(19) United States
(12) Patent Application Publication
(10) Pub. No.: US 2019/0130764 A1
(43) Pub. Date: May 2, 2019

(54) SYSTEM AND METHOD FOR PROVIDING PARKING NAVIGATION FOR A FIELD SERVICE VEHICLE

(71) Applicant: salesforce.com, inc., San Francisco, CA (US)

(72) Inventor: VIJAY KARANI, SARATOGA, CA (US)

(73) Assignee: salesforce.com, inc., San Francisco, CA (US)

(21) Appl. No.: 15/796,399

(22) Filed: Oct. 27, 2017

(51) Int. Cl. G08G 1/00; G08G 1/14; G08G 1/0968; G01C 21/34

(52) U.S. Cl. CPC G08G 1/205; G08G 1/202; G01C 21/3461; G08G 1/0968; G08G 1/146

(57) ABSTRACT

A system and method for providing parking navigation for a field service vehicle has been developed. First, a destination and length of stay for the field service vehicle is determined. Next, a listing of available parking locations in proximity to the destination is retrieved with a parking navigation system located on-board the vehicle. A list of available parking locations for the field service vehicle is selected based on the estimated length of stay at the service destination, any physical requirements of the field service vehicle and efficient access to the destination. The selected parking location is transmitted to the driver of the field service vehicle with the parking navigation system.

### TECHNICAL FIELD

Embodiments of the subject matter described herein relate generally to vehicle navigation. More particularly, embodiments of the subject matter relate to a system and method for providing parking navigation for field service vehicle.

### BACKGROUND

Efficient dispatch and route planning for field service vehicles are important for various reasons, such as time optimization. Such planning is more difficult when parking considerations for the vehicle are taken into account. Many field service vehicles have special considerations due to the length of their anticipated stay at their location as well as size requirements for access, loading, unloading, etc. Searching for an adequate parking location may consume an inordinate amount of time for a field service vehicle.

Accordingly, it is desirable to provide optimized parking navigation for field service vehicle. Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic block diagram of an exemplary multi-tenant computing environment;

FIG. 2 is a schematic block diagram of a system for providing parking navigation to a field service vehicle in accordance with certain embodiments;

FIG. 3 is a schematic block diagram of a network for providing parking navigation to a fleet of field service vehicles in accordance with certain embodiments; and

FIG. 4 is a flowchart of a method for providing parking navigation to a field service vehicle in accordance with certain embodiments.

### DETAILED DESCRIPTION

A system and method for providing parking navigation for a field service vehicle has been developed. Embodiments include determining the destination for the field service vehicle along with estimated stay at the destination. A parking navigation system retrieves the list of available parking locations in proximity to the destination and selects an optimum parking location for the vehicle. The selection is automatically based on the estimated length of stay, any physical requirements of the field service vehicle and efficient access to the destination. The selected parking location is transmitted to the driver through the parking navigation system on board the vehicle. Embodiments may be implemented through use of a multi-tenant system, although such a multi-tenant system is not a requirement.

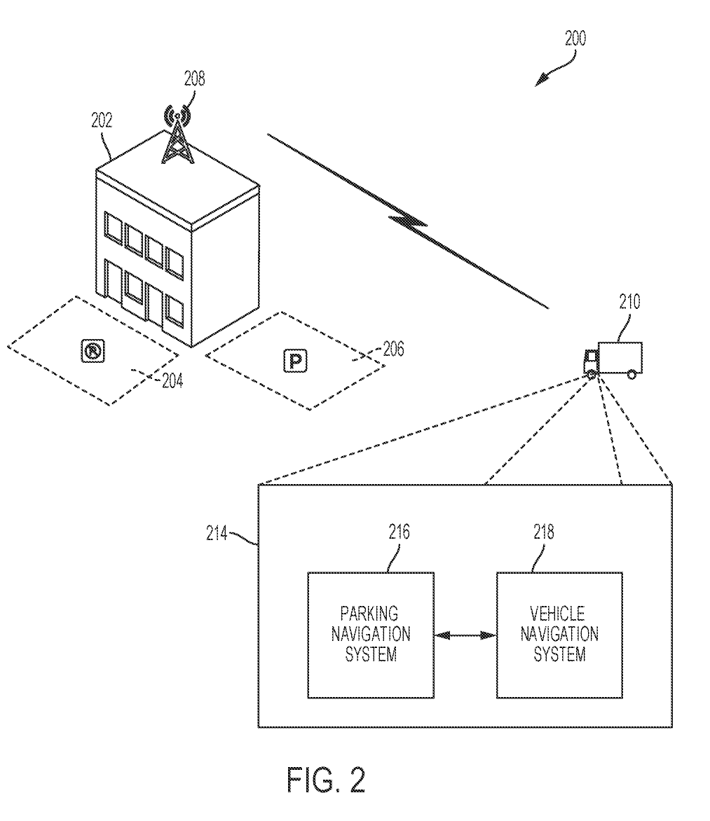

Turning now to FIG. 2, a block diagram 200 is shown of a system for providing parking navigation for field service vehicle 210 in accordance with one embodiment. In this embodiment, a field service destination 202 has a real-time parking monitor 208 that monitors the availability of parking locations 204 and 206 in proximity to the destination 202. The parking monitor 208 creates a list categorizing the parking availability as either unavailable 204 or available 206. The list of available parking locations is transmitted to a field service vehicle 210 that is equipped with a field service control device 214.

The real-time parking monitor may be a third-party system that provides data to the parking navigation system for the field service vehicle. In other embodiments, the parking monitor may be an integral part of the parking navigation system that is installed and operated by the owner for specific use with a field service vehicle. The parking monitor may determine the availability of parking locations with the use of various sensors, detectors, or other subsystems configured to monitor parking areas in proximity to the location. Such sensors may include cameras, lidar, image detectors, traffic sensors, as well as other data sources that provide information concerning parking availability. Parking availability is determined by requirements such as: occupation of a specific parking space by another vehicle; blocking a parking space by obstructions such as construction or traffic; accessibility of a parking space for the field service vehicle based on its height, width, clearance, weight, maneuver requirements (e.g., turning radius, etc.); and accessibility to required features of the destination (e.g., loading dock, etc.). Such characteristics as the physical dimensions of the available parking may be preloaded into a database for the parking monitor since that data is relatively static and would only require periodic updates instead of continual monitoring.

The characteristics of parking availability, as gathered by the parking monitor, may be categorized as a listing of suitable parking locations that are available in proximity to the destination for the field service vehicle. The listing of suitable parking locations along with other supporting data that may be of the interest to the field service vehicle is transmitted wirelessly from the parking monitor to the field service vehicle. The listing may categorize the available parking locations based on preferences and requirements of the field service vehicle. For example, proximity to the location may be a more important criteria if the field service vehicle is tasked with loading or unloading heavy cargo at the destination. Likewise, a parking location with quick and easy access may be a more important criteria if the field service vehicle is tasked with a brief stop at the destination. The criteria and their relative importance may be selected by the operator of the field service vehicle and input into the field service control device.

The field service control device may be an integrated subsystem of a broader field service application in some embodiments. In other embodiments, the field service control device may be a separate and distinct system that is part of the vehicle's navigation system. In still other embodiments, the field service control device may be a separate handheld mobile device used by the driver of the field service vehicle or it may be a separate software application for a smart phone, tablet, or other mobile communications device. The field service control device may be loaded with such preliminary information as: the destination; the type of work to be done by the field service vehicle; the physical dimensions and requirements of the field service vehicle; any physical requirements for the scheduled work; the estimated length of stay to complete the scheduled work; etc. This information may be loaded automatically prior to the field service vehicle departing its dispatch point. In other embodiments, the driver may manually load or modify the information in the field service control device.

The field service control device 214 has a parking navigation system application 216 in communication with a vehicle navigation system 218. The parking navigation system 216 receives the listing of available parking locations provided by the real-time parking monitor 208 and selects a parking location automatically based on the estimated length of stay for the field service vehicle 210 at the destination 202, any physical requirements of the search field service vehicle 210 and efficient access to the destination 202. The field service control device 214 will use the vehicle navigation system to 18 to select a navigation route to the selected parking location. In some embodiments, the field service control device may be a mobile communications device such as a smart phone or tablet that is hand carried by the driver of the field service vehicle.

In this example, the parking monitor 208 not only monitors the availability of parking locations, but also monitors the dimensions of individual parking locations, the proximity of an individual parking locations to the destination 202, any obstructions in the vicinity of the parking location (e.g., construction activity, road conditions, weather conditions, traffic conditions, obstacles that may hinder the movement of the field service vehicle, etc.). This information is collected along with any other data that may be useful for the parking navigation system 214 to use in selecting an available parking location for the field service vehicle 210.

Additionally, the parking monitor may provide a current list of anticipated available parking locations based on historical data. For example, parking availability may be increased before or after normal work hours, during lunch time, or on holidays, etc. This allows the parking navigation system 216 to select an available parking location based on the anticipated time of arrival of the field service vehicle 210 at the destination 202.

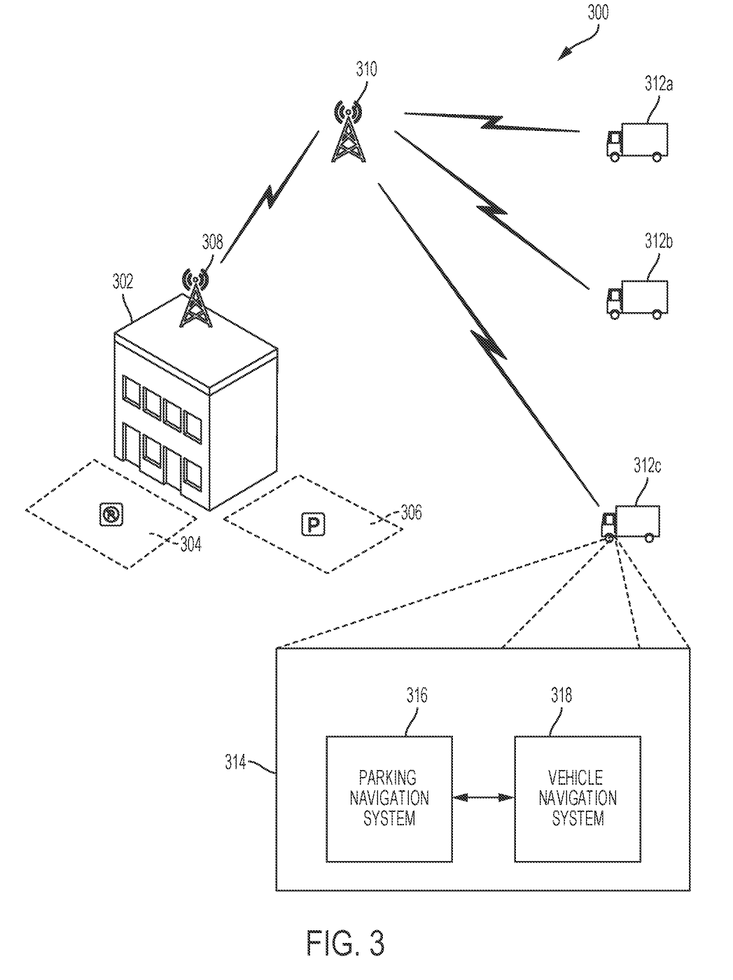

Turning now to FIG. 3, a block diagram 300 of a network system for providing parking navigation for a fleet of field service vehicles 312a-312c is shown in accordance with one embodiment. This embodiment is similar to the system shown previously in FIG. 2 with a destination 302 and a real-time parking monitor 308 that monitors available parking locations 306 and non-available parking locations 304 in proximity to the destination 302. The parking monitor 308 monitors the same criteria such as physical dimensions, road, weather, traffic, and construction conditions in proximity to the parking locations as described previously.

The listing and details for available parking locations are transmitted from the parking monitor 308 to a field dispatch controller 310. The field dispatch controller 310 may also receive similar data from other service destinations and real-time parking monitors throughout its area of responsibility. The field dispatch controller 310 coordinates with the fleet of field service vehicles 312a-312c to designate an available parking location for the service vehicle 312c assigned to the destination 302. In this embodiment, the field dispatch controller will select the available parking location based on the estimated length of stay at the destination, any physical requirements of the field service vehicle and efficient access to the destination.

The field dispatch controller 310 will also select a navigation route to the available parking location and transmit the route to a field service communication device 314 located on the field service vehicle 312c. The field service communication device contains a parking navigation system 316 and a vehicle navigation system 318 that receives the navigation route to the available parking location and display it to the driver of the field service vehicle 312c.

In other embodiments, the field dispatch controller monitors the available parking locations in real time and may reroute the dispatch of the field service vehicles based on changing availability, calendar/time of service or distance to the service site. For example, the field dispatch controller may reschedule or reroute the field service vehicles based on fuel efficiency, time efficiency, site or traffic conditions as well as the work priority.

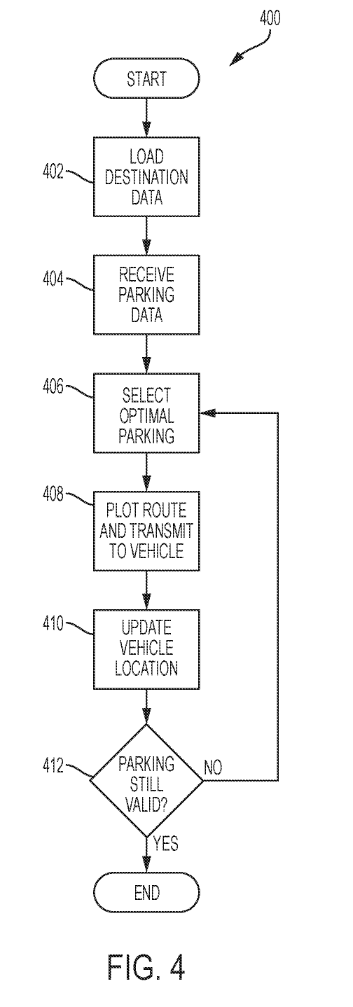

Turning now to FIG. 4, a flowchart 400 is shown for a method of providing parking navigation for a field service vehicle in accordance with one embodiment. First, the destination data is loaded onto a field service control device located on board the field service vehicle 402. The destination data for the field service vehicle may include the estimated length of stay at the destination, as well as any physical requirements for the field service vehicle to access the location. Examples of these requirements may include the physical dimensions of the field service vehicle such as length, clearance, and other physical requirements for tasks such as loading, unloading, or accessing the destination. The requirements may be automatically loaded by a field dispatch controller prior to the departure of the field service vehicle. In other embodiments, the information may be manually loaded by the driver. In still other embodiments, the requirements may be updated via a wireless communications link from the field service dispatch controller or updated manually by the driver.

Next, the field service control device will receive parking data from a real-time parking monitor for the destination 404. The field service control device contains a parking navigation system that will select a parking location for the field service vehicle based on the estimated length of stay at the destination, any physical requirements for the field service vehicle and optimal and efficient access to the destination 406. The field service control device also includes a vehicle navigation system that will receive the selected parking location and select the navigation route for the field service vehicle 408. As the vehicle field service vehicle travels to the destination, it's location is updated by the vehicle navigation system 410. The real-time parking monitor will continue to monitor the listing of available parking locations and update the parking locations for the field service vehicle if the previously transmitted selected parking location is no longer available 412. If such a selected parking location is no longer available an updated location will be selected and sent to the field service control device and the vehicle navigation system.

In other embodiments, the parking navigation system may select a parking location based on anticipated availability for the projected arrival time of the field service vehicle. This anticipated availability may be based on historical data such as rush-hour traffic conditions, workday schedules, lunchtime traffic, etc.

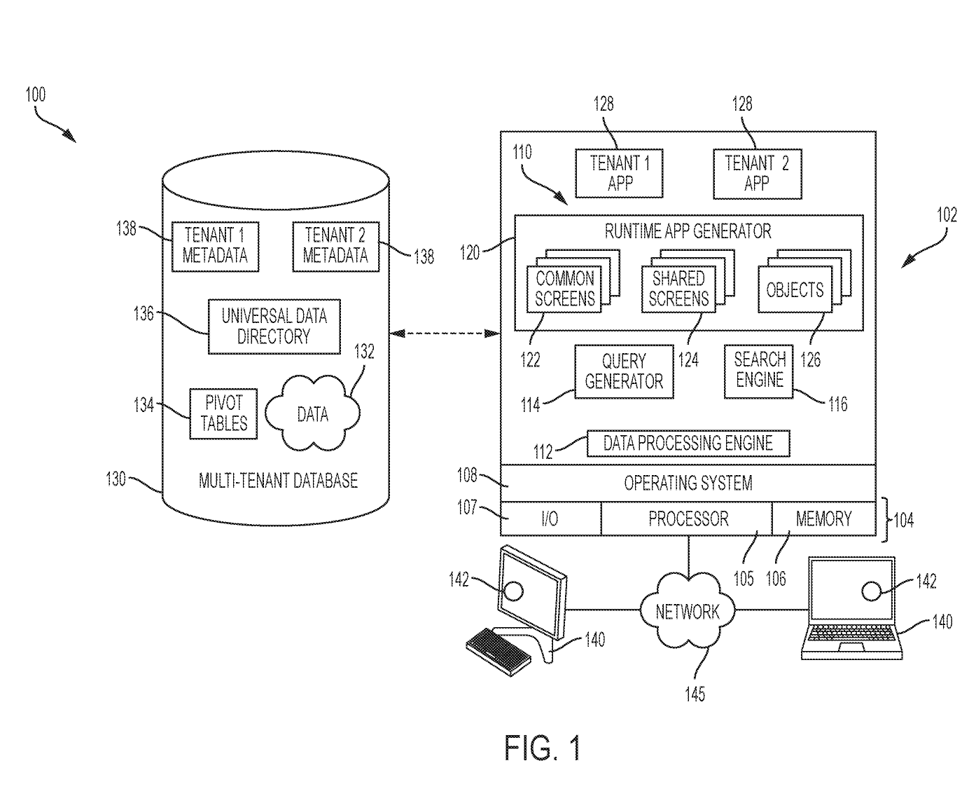

Turning now to FIG. 1, an exemplary multi-tenant system 100 includes a server 102 that dynamically creates and supports virtual applications 128 based upon data 132 from a database 130 that may be shared between multiple tenants, referred to herein as a multi-tenant database. This embodiment represents features of one possible computer based implementation. Data and services generated by the virtual applications 128 are provided via a network 145 to any number of client devices 140, as desired. Each virtual application 128 is suitably generated at run-time (or on-demand) using a common application platform 110 that securely provides access to the data 132 in the database 130 for each of the various tenants subscribing to the multi-tenant system 100. In accordance with one non-limiting example, the multi-tenant system 100 is implemented in the form of an on-demand multi-tenant customer relationship management (CRM) system that can support any number of authenticated users of multiple tenants.

As used herein, a “tenant” or an “organization” should be understood as referring to a group of one or more users that shares access to common subset of the data within the multi-tenant database 130. In this regard, each tenant includes one or more users associated with, assigned to, or otherwise belonging to that respective tenant. Stated another way, each respective user within the multi-tenant system 100 is associated with, assigned to, or otherwise belongs to a particular one of the plurality of tenants supported by the multi-tenant system 100. Tenants may represent companies, corporate departments, business or legal organizations, and/or any other entities that maintain data for particular sets of users (such as their respective customers) within the multi-tenant system 100. Although multiple tenants may share access to the server 102 and the database 130, the particular data and services provided from the server 102 to each tenant can be securely isolated from those provided to other tenants. The multi-tenant architecture therefore allows different sets of users to share functionality and hardware resources without necessarily sharing any of the data 132 belonging to or otherwise associated with other tenants.

The multi-tenant database 130 may be a repository or other data storage system capable of storing and managing the data 132 associated with any number of tenants. The database 130 may be implemented using conventional database server hardware. In various embodiments, the database 130 shares processing hardware 104 with the server 102. In other embodiments, the database 130 is implemented using separate physical and/or virtual database server hardware that communicates with the server 102 to perform the various functions described herein. In an exemplary embodiment, the database 130 includes a database management system or other equivalent software capable of determining an optimal query plan for retrieving and providing a particular subset of the data 132 to an instance of virtual application 128 in response to a query initiated or otherwise provided by a virtual application 128, as described in greater detail below. The multi-tenant database 130 may alternatively be referred to herein as an on-demand database, in that the multi-tenant database 130 provides (or is available to provide) data at run-time to on-demand virtual applications 128 generated by the application platform 110, as described in greater detail below.

In practice, the data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired. Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants. Tenant-specific formatting, functions and other constructs may be maintained as tenant-specific metadata 138 for each tenant, as desired. Rather than forcing the data 132 into an inflexible global structure that is common to all tenants and applications, the database 130 is organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

The server 102 may be implemented using one or more actual and/or virtual computing systems that collectively provide the dynamic application platform 110 for generating the virtual applications 128. For example, the server 102 may be implemented using a cluster of actual and/or virtual servers operating in conjunction with each other, typically in association with conventional network communications, cluster management, load balancing and other features as appropriate. The server 102 operates with any sort of conventional processing hardware 104, such as a processor 105, memory 106, input/output features 107 and the like. The input/output features 107 generally represent the interface(s) to networks (e.g., to the network 145, or any other local area, wide area or other network), mass storage, display devices, data entry devices and/or the like. The processor 105 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 106 represents any non-transitory short or long term storage or other computer-readable media capable of storing programming instructions for execution on the processor 105, including any sort of random access memory (RAM), read only memory (ROM), flash memory, magnetic or optical mass storage, and/or the like. The computer-executable programming instructions, when read and executed by the server 102 and/or processor 105, cause the server 102 and/or processor 105 to create, generate, or otherwise facilitate the application platform 110 and/or virtual applications 128 and perform one or more additional tasks, operations, functions, and/or processes described herein. It should be noted that the memory 106 represents one suitable implementation of such computer-readable media, and alternatively or additionally, the server 102 could receive and cooperate with external computer-readable media that is realized as a portable or mobile component or platform, e.g., a portable hard drive, a USB flash drive, an optical disc, or the like.

The application platform 110 is any sort of software application or other data processing engine that generates the virtual applications 128 that provide data and/or services to the client devices 140. In a typical embodiment, the application platform 110 gains access to processing resources, communications interfaces and other features of the processing hardware 104 using any sort of conventional or proprietary operating system 108. The virtual applications 128 are typically generated at run-time in response to input received from the client devices 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the client devices 140. The virtual applications 128 are typically constructed in accordance with the tenant-specific metadata 138, which describes the particular tables, reports, interfaces and/or other features of the particular application 128. In various embodiments, each virtual application 128 generates dynamic web content that can be served to a browser or other client program 142 associated with its client device 140, as appropriate.

The runtime application generator 120 suitably interacts with the query generator 114 to efficiently obtain multi-tenant data 132 from the database 130 as needed in response to input queries initiated or otherwise provided by users of the client devices 140. In a typical embodiment, the query generator 114 considers the identity of the user requesting a particular function (along with the user's associated tenant), and then builds and executes queries to the database 130 using system-wide metadata 136, tenant specific metadata 138, pivot tables 134, and/or any other available resources. The query generator 114 in this example therefore maintains security of the common database 130 by ensuring that queries are consistent with access privileges granted to the user and/or tenant that initiated the request.

With continued reference to FIG. 1, the data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc.

In exemplary embodiments, the application platform 110 is utilized to create and/or generate data-driven virtual applications 128 for the tenants that they support. Such virtual applications 128 may make use of interface features such as custom (or tenant-specific) screens 124, standard (or universal) screens 122 or the like. Any number of custom and/or standard objects 126 may also be available for integration into tenant-developed virtual applications 128. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system. The data 132 associated with each virtual application 128 is provided to the database 130, as appropriate, and stored until it is requested or is otherwise needed, along with the metadata 138 that describes the particular features (e.g., reports, tables, functions, objects, fields, formulas, code, etc.) of that particular virtual application 128. For example, a virtual application 128 may include a number of objects 126 accessible to a tenant, wherein for each object 126 accessible to the tenant, information pertaining to its object type along with values for various fields associated with that respective object type are maintained as metadata 138 in the database 130. In this regard, the object type defines the structure (e.g., the formatting, functions and other constructs) of each respective object 126 and the various fields associated therewith.

Still referring to FIG. 1, the data and services provided by the server 102 can be retrieved using any sort of personal computer, mobile telephone, tablet or other network-enabled client device 140 on the network 145. In an exemplary embodiment, the client device 140 includes a display device, such as a monitor, screen, or another conventional electronic display capable of graphically presenting data and/or information retrieved from the multi-tenant database 130, as described in greater detail below. Typically, the user operates a conventional browser application or other client program 142 executed by the client device 140 to contact the server 102 via the network 145 using a networking protocol, such as the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 128, the runtime application generator 120 suitably creates the application at run time based upon the metadata 138, as appropriate. As noted above, the virtual application 128 may contain Java, ActiveX, or other content that can be presented using conventional client software running on the client device 140; other embodiments may simply provide dynamic web or other content that can be presented and viewed by the user, as desired. As described in greater detail below, the query generator 114 suitably obtains the requested subsets of data 132 from the database 130 as needed to populate the tables, reports or other features of the particular virtual application 128.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

“Node/Port”—As used herein, a “node” means any internal or external reference point, connection point, junction, signal line, conductive element, or the like, at which a given signal, logic level, voltage, data pattern, current, or quantity is present. Furthermore, two or more nodes may be realized by one physical element (and two or more signals can be multiplexed, modulated, or otherwise distinguished even though received or output at a common node). As used herein, a “port” means a node that is externally accessible via, for example, a physical connector, an input or output pin, a test probe, a bonding pad, or the like.

“Connected/Coupled”—The following description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, although the schematic shown in FIG. 2 depicts one exemplary arrangement of elements, additional intervening elements, devices, features, or components may be present in an embodiment of the depicted subject matter.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The various tasks performed in connection with the process of providing parking navigation for a field service vehicle may be performed by software, hardware, firmware, or any combination thereof. For illustrative purposes, the following description of the process may refer to elements mentioned above in connection with FIGS. 1-3. In practice, portions of the process may be performed by different elements of the described system, e.g., component A, component B, or component C. It should be appreciated that the process may include any number of additional or alternative tasks, the tasks shown in FIG. 3 need not be performed in the illustrated order, and the process may be incorporated into a more comprehensive procedure or process having additional functionality not described in detail herein. Moreover, one or more of the tasks shown in FIG. 3 could be omitted from an embodiment of the process as long as the intended overall functionality remains intact.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A system for providing parking navigation for field service vehicle, comprising:
a real-time parking monitor located at a destination for the field service vehicle, where the parking monitor detects available parking locations; and
a field service control device located on the field service vehicle, comprising,
a parking navigation system that selects a parking location for the field service vehicle from the listing of available parking locations provided by the real-time parking monitor, where the selected parking location is automatically selected based on the estimated length of stay of the field service vehicle at the destination, any physical requirements of the field service vehicle and efficient access to the destination, and
a vehicle navigation system that detects the selected parking location and selects a navigation route to the parking location for the field service vehicle.

2. The system of claim 1, where the real-time parking monitor detects physical dimensions of the available parking locations.

3. The system of claim 1, where the real-time parking monitor detects obstructions in the vicinity of the available parking locations.

4. The system of claim 3, where the obstructions comprise physical obstacles to the movement of the field service vehicle.

5. The system of claim 1, where the physical requirements of the field service vehicle are automatically loaded into the parking navigation system.

6. The system of claim 1, where the physical requirements of the field service vehicle are manually loaded into the parking navigation system by a driver of the field service vehicle.

7. The system of claim 1, where the field service control device is a mobile communication device.

8. A network system for providing parking navigation for a fleet of field service vehicles, comprising:
a plurality of real-time parking monitors located at multiple destinations for the fleet of field service vehicles, where the parking monitors detect available parking locations near each destination;
a field dispatch controller that receives a listing of available parking locations near each destination from the real-time parking monitors, where the field dispatch controller,
selects an available parking location for each field service vehicle from the listing of available parking locations, where the selected available parking location is automatically selected based on the estimated length of stay of the field service vehicle at the destination, any physical requirements of the field service vehicle and efficient access to the destination,
selects a navigation route to the available parking location for the field service vehicle, and
transmits the navigation route to the available parking location for the field service vehicle; and
a field service communication device located on each field service vehicle that receives the navigation route to the available parking location and displays the navigation route to a driver of the field service vehicle.

9. The network system of claim 8, where the field dispatch controller revises the navigation routes for each field service vehicle based on available parking locations.

10. The network system of claim 8, where the field dispatch controller revises the navigation routes for each field service vehicle based on calendar or time of service.

11. The network system of claim 8, where the field dispatch controller revises the navigation routes for each field service vehicle based on the distance to the service site.

12. The network system of claim 8, where the field dispatch controller revises the navigation routes for each service vehicle based on time efficiency as determined by available parking locations.

13. A method for providing parking navigation for a field service vehicle, comprising:
determining a destination for the field service vehicle;
determining an estimated length of stay for the field service vehicle at the destination;
retrieving a listing of available parking locations in proximity to the destination using a parking navigation system located on-board the vehicle;
selecting a parking location for the field service vehicle from the listing of available parking locations, where the selected parking location is automatically selected by the parking navigation system based on the estimated length of stay at the destination, any physical requirements of the field service vehicle and efficient access to the destination; and
transmitting the selected parking location to a driver of the field service vehicle with the parking navigation system.

14. The method of claim 13, further comprising:
monitoring the listing of available parking locations prior to the arrival of the field service vehicle at the destination;
updating the selected parking location for the field service vehicle if the previously transmitted selected parking location is no longer available; and
transmitting the updated selected parking location to the driver of the field service vehicle with the parking navigation system.

15. The method of claim 13, where the selected parking location for the field service vehicle is selected by the parking navigation system based on current availability.

16. The method of claim 13, where the selected parking location for the field service vehicle is selected the parking navigation system based on anticipated availability.

17. The method of claim 16, where the anticipated availability of the selected parking location is based on historical data from a database that is accessible a real time parking monitor located at the destination.

18. The method of claim 13, where the selected parking location for the field service vehicle is selected the parking navigation system based on time efficiency for the estimated length of stay at the destination.

19. The method of claim 18, where the time efficiency is determined by the parking navigation system based on the proximity of the selected parking location to the destination.
